(19) United States
(12) Patent Application Publication
(10) Pub. No.: US 2008/0005002 A1
(43) Pub. Date: Jan. 3, 2008

(54) Secure Communication Network Operating Between a Cental Administrator, Operating as a Hedge Fund of Funds, and Numerous Separate Investment Funds

(75) Inventor: Gavin Robert Ferris, County Down (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: CRESCENT TECHNOLOGY LIMITED, Dublin (IE)

(21) Appl. No.: 11/576,900

(22) PCT Filed: Oct. 10, 2005
(86) PCT No.: PCT/GB05/03887

§ 371 Date: May 21, 2007

(30) Foreign Application Priority Data
Oct. 8, 2004 (GB) 0422411.9

(51) Int. Cl. G06Q 40/00

(52) U.S. Cl. 705/36 R

(57) ABSTRACT

A secure communication network operates between a central administrator (a hedge fund of funds), and numerous separate investment funds, each investment fund including several different instruments; each instrument in a portfolio is modelled as a software component that responds to a common risk factor response API. This addresses technical implementation issues associated with a second aspect of the invention, namely a method in which the FoFs actively sets a risk budget for its underlying, individual funds or associated managers. The risk budget can be dynamically set by the hedge funds of funds in real time using a secure electronic protocol.

### BACKGROUND OF THE INVENTION

1. Field of the Invention

This invention relates to a secure communication network operating between a central administrator, operating as a hedge fund of funds, and numerous separate investment funds. It relates also to a method of enabling a hedge fund of funds to manage risk.

2. Description of the Prior Art

Traditionally, hedge fund of funds (FoFs) have had relatively little control over their underlying investments. There have been three main reasons for this. First, the level of risk transparency from the average hedge fund has generally been poor. While the approach of managed accounts goes some way towards addressing this, many successful funds refuse to provide them, and in any event, full position transparency puts a huge analysis load on the FoF manager and raises many complex technical problems of IT integration—i.e. efficiently giving the FoF access controlled visibility to highly sensitive investment data held on the IT systems of each fund.

Secondly, whatever reporting data is received, the FoF manager can do little to modulate the behavior of the underlying funds themselves, other than to vary the allocation to that fund within the FoF portfolio. Clearly, ‘allocation’ is not the only lever that a FoF manager would like to be able to manipulate. Dynamic control of other metrics, such as the fund's exposure to key risk factors, liquidity, volatility and leverage, would be useful. Yet in current architectures, the FoF manager is often constrained towards being a passive observer of these behaviors in its funds—even though the better constructed funds will actively be managing certain if not all of these ‘levers’ themselves.

Finally, the point must be made that while funds aim to construct the best risk-adjusted ‘outcome’ from a standalone perspective, given the trading strategies they employ—the best standalone fund is not necessarily the best portfolio addition. The FoF manager is—or should be—concerned with the latter goal. Yet conventional architectures do not allow the fundamental cross-fund control that is common within the corporate veil of the funds themselves. The FoF manager has a ‘take it or leave it’ choice to make from a menu of historical profiles of individual funds. This, we would contest, is not the ideal way to build an optimized portfolio, particularly so since many of the funds are not executing simple atomic strategies but are actively managing their own risk budgets. Because of this, a non-trivial layer of optimization -often against an unhelpful objective function—has already taken place to create the packaged product in which the FoF is invited to participate wholesale. Ideally the FoF manager would like this risk budgeting to be distributed and global, not concentrated and local with only a final aggregation due to the FoF.

Yet it might well be asked—do fund of funds really need to change? Is there any threat to the current paradigm, even if it is somewhat inefficient? The simple answer is yes, there is a threat—and it comes in the form of integrated ‘multi-strategy’ funds. These players, which integrate a number of different (and partially offsetting) trading systems within a common risk and money management framework, have a number of potential advantages over FoFs. Specifically, multi-strats can control more parameters of their underlying ‘funds’, they can control these parameters in ‘real time’, and (critically from a institutional customer's point of view) they do not charge an extra layer of fees. There is now a teal and growing pressure on ‘traditional’ fund of funds to demonstrate that they are really providing the alpha that their additional layer of fees suggests. We contest that, increasingly, being a good passive aggregator will no longer be sufficient to win at this game.

Currently, the vast majority of fund of funds (FoFs) act as an ‘intelligent aggregators’ of their underlying hedge funds. Active, parametric risk control of these funds is non-existent (other than is imposed by the initial filter used to select the funds)—for example, FoFs are unable to say ‘you must keep your beta to the S&P 500 below 0.3, and the orthogonalized residual beta to the small cap style below 0.2′, or any similar edict. Funds are left to select their own risk budget and then optimize a ‘local’ portfolio that provides, in general, the best possible risk adjusted return within that framework. Having done this, funds will generally report relatively little information on their holdings, total level of risk, and overall attribution; and the statistics that are presented to the investing FoF are generally reported with a lag. To make things worse, there is no standardized methodology of reporting used by funds, making it difficult to know when measurements are commensurate.

Now, as Alexander Ineichen of UBS points out (see Absolute Returns: The Risk and Opportunities of Hedge Fund Investing, Wiley Finance Series (Hoboken, N.J., USA: John Wiley & Sons, Inc, 2003), FoFs are able to charge an additional fee layer primarily because of three factors:
The hedge fund market is opaque and full of inefficiencies. It is difficult to tell a good fund from a bad one. This is where the skilled FoF can bring experience, due diligence etc. to bear. In this sense, a FoF stands in the relation of a venture capitalist to its investors.
The FoF to some degree acts as a gatekeeper of capacity for certain funds; in any event, it provides an aggregation function that allows its investors access to higher-quantum underlying products.
The FoF acts as a diversifier of business (and other idiosyncratic) risk associated with the underlying funds.

Arguably, the latter two advantages can largely be achieved by utilizing investable hedge fund indices, so the primary advantage to a FoF is one of the ongoing due diligence. Against a multi-strat the main advantages are access to a more diverse pool of alpha, and the diversified business risk. However, as we shall see, the FoF may not be able to outperform the multi-strat, even gross of fees.

Fund of Funds as Aggregators

As noted above, a key issue for FoFs is that they primarily act as aggregators of the performance of their underlying funds, as is illustrated in the FIG. 1 diagram of the allocate/execute/report/optimise/allocate cycle.

Clearly, this ‘passive’ approach has certain problems:
The funds are optimizing their own portfolios according to their own risk parameters (the first two boxes counting from the left on each row). This means that the FoF does not get to modify the internal risk parameters of the fund, and has little impact over the behavior of funds other than by their inclusion/non-inclusion into the portfolio. This opacity fosters the temptation for style drift—whereby managers explicitly or implicitly allow their risk parameters to change without signaling this to their investors.
Funds are generally trying to optimize their own returns, which means having sufficient strategy risk to bring upside on the performance fees and low enough volatility (relative to their peers) to keep allocations positive, so that management fees can also increase (strong performance grows the AUM which raises the base for management fees, but this is a secondary effect in a successful fund). Often these ‘local optimizations’ may actually be detrimental to the aims of the aggregating FoF, which can only work with the output risk profiles to perform its global optimization. What makes the best standalone fund may not be the best choice from a FoF portfolio perspective. Note that even where a FoF has a managed account with a fund, the latter is unlikely to want the FoF to ‘assist’ in setting the risk parameters, since the economic interests of the fund managers (given the performance/management fee structure) lies with generating the best return possible, given the trading strategies available within that fund alone.
The only ‘lever’ the FoF can move is allocation of assets to each fund in the portfolio construction; and that, only after results are provided by that fund. As illustrated in FIG. 1, these results can come in with different granularities and lag (e.g., some funds only report monthly NAV, and with a 2-week lag, whereas managed accounts generally provide near-real-time position information).
The risk information provided by various funds to the FoF will generally vary widely; there is little standardization. While managed accounts provide position level transparency, this is not useful by itself—the data must be processed by the recipient FoF to create a detailed risk analysis. Again, as a chain is only as strong as its weakest link, even a diligent FoF performing e.g. risk factor decomposition on this data would only have partial information in the case where some of the funds report only monthly statistics. Worse still, many funds report statistics that allow only for a univariate understanding of risk (e.g. VaR) but not an explanatory, factor-based understanding of risk (e.g. a beta of 0.4 to the S&P 500, with a residual beta of 0.2 to the large-cap style, etc.)
The FoF cannot change allocations to a fund at too rapid a rate (for example, by redeeming a large amount of capital 3 months after it was allocated), since to do so might poison the relationship with that fund (which does not want ‘hot money’) and therefore reduce the availability of future capacity. Similarly, there may well be redemption penalties/liquidity notice periods gates etc that prevent allocations being rapidly changed. This makes it difficult for the FoF to operate in anything other than ‘slow motion, in response to delayed and often incomplete information’.

As may be appreciated then, the process of fund of fund construction is currently challenging, according to the current state of the art. On the other hand, there are some bright spots: as Richard Horwitz points out in Hedge Fund Risk Fundamentals: Solving the Risk Management and Transparency Challenge (Princeton, N.J., USA: Bloomberg Press, 2004), FoFs are generally long and often have sub-30 holdings, which puts them in the sweet spot for using optimizers successfully.

However, there is one major threat to the existing order of FoFs, as pointed out by Ineichen and others, and that is the emergence of multi-strategy funds (multi-strats).

The Threat to FoFs from Multi-Strats

Multi-strats generally start life as successful single strategy (or at least, single style) funds, which, having had a successful run, find themselves with significant assets under management and look to diversify their risk (and also, gain additional capacity to ensure that their asset base can continue to grow). The way that the funds which become multi-strats solve this problem is to bring additional alpha-generating sub-funds in house, either created through innovative research or through the addition of new outside talent. In any event, since the strategies are hosted within a single company, it is possible to have full transparency, and also, to set the risk budgeting explicitly for each sub-component dynamically, in real time (if desired) and in a manner that allows the overall portfolio construction to have better optimization of risk.

Therefore, modulo their ability to house sufficient disparate sources of uncorrelated alpha, multi-strats should have a performance edge over FoFs. What's more, not only can they move more ‘risk levers’ (such as volatility constraints) for each of their strategies, they can also reallocate in a much more brutal and rapid manner, and without cost other than natural liquidity charges. Furthermore, on a pragmatic level a multi-strat charges only a single layer of fees—putting, from an institutional customer's perspective, a sharp point to the question of the FoF's added value.

How can FoFs respond to this growing challenge? One approach would be to ignore it, but this is unlikely to yield an optimal outcome. FoFs can (and have) tried to stress the following points in their defense:
Multi-strats cannot get access to sufficient alpha. Well it is certainly true that the FoF can go wherever it likes for alpha, and that many talented managers will only work inside the confines of their own funds, but with more integrated approach to risk and money management, multi-strats can often more than close the performance gap created by this issue. Plus (to cloud the issue) some multi-strats act like semi-FoFs by buying tranches of other funds directly.
Multi-strats do not diversify idiosyncratic business risk. There's more to this argument, although it is unlikely that most institutional investors would regard it as good enough reason to pay the fees of a FoF. They may simply build their own long portfolio of a small number of multi-strats to solve the problem.

As may be appreciated, the arguments for FoFs are not compelling, and, the more institutional the market becomes, the stronger will be the pressure on FoFs to reduce fees, or add some additional value to justify them. Assuming that FoFs will not want to embrace the former suggestion, we contest that to achieve the latter and increase their alpha, there is a compelling way to proceed.

### SUMMARY OF THE INVENTION

The present invention addresses two separate problems. First, can FoFs be re-designed from a business model perspective to address the challenges outlined above? Secondly, assuming one already has such a new business model, what are the technical issues to implementing that business model—i.e. to the technical problems that one is faced in actually building a working, computer implemented system.

In summary, the new business model is predicated on the FoFs actively setting a risk budget for its underlying, individual funds or associated managers, as opposed to merely deciding on a risk budget for the FoF itself through the crude mechanism of including some funds and not others. This will be explained and amplified below. But this business model immediately raises significant questions in terms of technical implementation. For example, one arguably obvious implementation would have each fund couple its own IT systems and expose its sensitive data to the IT systems of the FoF (acting in a role that we shall refer to as a ‘central administrator’). The FoF IT systems then interrogate and analyse each fund's detailed data performance data looking at each instrument that the fund is invested in) and determine whether the risk budget imposed by the FoF is adhered to. But with that approach, how does the FoF cope with the fact that different funds will have entirely different IT systems that will need to be interacted with in entirely different ways, with differing interrogation and response formats? Also, can the fund in some manner expose only the information that the FoF needs, without revealing anything else, in order to minimise security risks?

The second aspect of the invention addresses these technical problems by proposing an approach that is entirely new and inventive in this context. It proposes that there is a secure communication network operating between the FoF (as a central administrator), and the numerous separate investment funds, each investment fund including several different instruments. Critically, each instrument in a portfolio is modelled as a software component that responds to a common risk factor response APL.

The use of a software component, responsive to a risk factor response API common to all funds, addresses the technical problems of what one might characterise as the routine and non-inventive solution—namely controlled, encrypted access to only certain aspects of a funds IT infrastructure being granted to the FoF's IT system. The present invention still preserves the internal security of the fund data, but does so because the API is restricted only to information relevant to risk factors (giving risk transparency). It does not allow much deeper exposure (e.g. what the fund is invested in and for how much and the circumstances in which it would buy/sell etc: position transparency): forced and malicious entry to that level of exposure is always a possibility with systems that in effect expose an IT infrastructure but then seek to control access to parts of it. The present invention also avoids the need for the FoF central administrator to be conversant with dozens of different IT systems and database structures and to be able tothandle potentially vast quantities of information—a potentially massive middleware problem and again likely to arise if the approach to implementing the business model is to give to the FoF access, albeit controlled, to multiple funds' IT infrastructure. The software components in effect operate as an insulation layer between the FoF and the underlying funds. They also enable (as noted above; it is one aspect of the invention) the FoF's central administrator to actively set a risk budget for its underlying, individual funds or associated managers.

Mapping instruments into active software components also enables complex, non-linear behavior to be represented. An instrument's component proxy can ‘respond’ (through its API) to queries that ask how the instrument's price would change in response to a modified environment (described as an n-tuple of the major risk factors previously disclosed). These queries do not rely upon the details of the underlying instrument itself being disclosed.

The risk budget can be actively or dynamically set by the FoF central administrator in real time using a secure electronic protocol. This would be very difficult to engineer if the FoF is simply given direct access to multiple funds' IT infrastructure because of the multiple inconsistent IT systems and database structures. Furthermore, the software components can interact with the central administrator across a virtual domain through remote procedure calls to enable a virtual portfolio to be constructed by the central administrator. This would be quite impossible with conventional techniques of passive data sharing—i.e. funds simply opening up their IT systems to the FOF.

Further, each instrument can declare or be queried using remote procedure calls to determine what queries are relevant and supported by the instrument. This gives the flexibility that would be absent from a homogenous solution of passive but deep data access.

The individual funds should utilise a common risk model or taxonomy that delivers risk transparency but not position transparency to the hedge fund of funds, facilitating the active setting of risk budgets by the hedge funds of funds. The common risk model allows each fund to perform or be subject to:
(a) predictive risk budgeting;
(b) portfolio evaluation during reporting; and
(c) retrospective performance attribution.

The risk model can be a taxonomy that expresses risk factors relating to leverage, liquidity, return volatility and correlation to key indices. The risk budget then uses the risk model to describe the applicable limits to the risk factors.

The Fof can also in real time globally optimise an actual or candidate portfolio of funds against a complex, objective function related to the risk budget, the objective function itself being modelled as a software component that also operates to the risk factor API. Again, this would be virtually impossible with conventional direct access to the IT infrastructures of multiple funds.

A trading strategy (as well as an instrument, described above) can also be treated as an instrument and modelled as a software component that responds to the common risk factor response API; this gives enhanced forward risk simulation of future portfolios.

As noted above, there is also a second aspect to the present invention. The second aspect covets a business model advance: it is a method of enabling the FoF to manage risk, comprising the step of the FoF actively setting a risk budget for its underlying, individual funds or associated managers. In the past, no such active risk budget has been set at all by a FoFs.

The risk budget can be expressed as one or more of the following:
(a) desired minimum and maximum exposures to each risk factor;
(b) desired minimum and maximum portfolio leverage;
(c) desired minimum and maximum time to liquidate various percentages of the portfolio;
(d) overall portfolio volatility minimum and maximum targets;
(e) overall portfolio return minimum and maximum targets; and
(f) maximum acceptable drawdowns in specified stress test scenarios.

Each fund can also create a separate segregated account that it uses to carry out trades for the FoF, the segregated account facilitating risk transparency and risk optimisation. The segregated account for a fund enables the FoF to determine compensation payments to be made to the fund to compensate the fund for operating in a way that conforms to the risk budget specified by the FoF. Compensation to a fund may be necessary for the business model to work because the risk budget that is optimal for the FoF globally (i.e. across all its funds) is not necessarily optimal in terms of individual performance and hence revenue generation for that particular fund.

### BRIEF DESCRIPTION OF THE DRAWINGS

The present invention will be described with reference to the accompanying drawings, in which:

FIG. 1 shows the conventional passive allocation cycle for FoFs;

FIG. 2 is a graph depicting the benefits of a globally optimal strategy versus aggregating locally optimal strategies, in a simple Markowitz risk model; the present invention implements a globally optimal strategy;

FIG. 3 depicts schematically how an aggregation of locally optimal strategies is not (usually) globally optimal;

FIG. 4 depicts schematically how the three core requirements of an implementation of the present invention impact the current status quo as shown in FIG. 1;

FIG. 5 depicts schematically a summary of the instrument interfaces deployed in an implementation of the present invention;

FIG. 6 is an overview of the RiskBLADE Architecture that implements the present invention—creating a distributed, virtual Multi-Strat;

FIG. 7 depicts schematically the improved FoF control and reporting flow with the RiskBLADE Architecture.

### DETAILED DESCRIPTION

If FoFs are to prosper and differentiate themselves in the increasingly competitive and institutionalized alternative assets marketplace, their risk budgeting and management architectures must evolve. FoFs must adopt a distributed risk-budgeting framework, which allows them to participate in setting the risk allocations for their underlying funds, using a secure electronic protocol that does not compromise the fund's proprietary trading strategies or current positions, in a manner that enables them to optimize portfolio risk across funds in real time. With such an approach, a FoF can, in effect, become a ‘virtual multi-strat’, but one which provides a degree of diversification against idiosyncratic business risk not present in multi-strats themselves. Through this latter benefit, plus access to a wider set of strategies, the additional fee layer can be justified. Furthermore, we believe that this approach can be integrated into a fund and legal structure in which ‘segregated accounts’ are utilized to provide FoFs with the risk control they need, with risk reporting that does not compromise the proprietary information of the underlying manager, and in which that manager is compensated though a custom OTC derivative for decisions that are sub-optimal from an absolute performance perspective but which make sense to the FoF from a global portfolio component perspective.

Our solution—a mix of technology and business practice/fund structuring—we have termed ‘RiskBLADE’: a networked, modular, active approach to risk budgeting across disparate funds for the mutual benefit of both the controlling FoF and the underlying managers.

Structure of this Detailed Description

We began earlier (Description of the Prior Art section) by considering the current structure of fund-of-funds (FoFs) and how they interact with their underling funds (current state of the art). Then, we considered the threat from multi-strategy funds. Now, we show that to successfully meet this challenge, FoFs need to increase their (usable) transparency, parametric risk control and optimal portfolio construction capabilities with respect to the funds in which they invest. We go on to consider briefly why managed accounts do not provide this, and review the current state-of-the art in ‘passive’ risk management (including Kenmar's Risk Fundamentals system), before going on to describe in more detail out own solution to this challenge—RiskBLADE. Our architecture provides for a distributed risk budgeting system over entities that we term ‘segregated accounts’, with the ability for FoFs to have much more control over the ‘control levers’ of the account, and to optimize with sophisticated objective functions between potentially competing) underlying funds, without compromising the individual positions of those funds. We also review a proposed ‘alpha swap’ derivative that would allow underlying funds to be compensated for the potentially lower individual performance of segregated accounts due to choices made by the cross-fund optimizer, again in a manner that operates without jeopardizing the current positions of the fund. Having introduced the RiskBLADE architecture, we then analyze it against the initial objectives to show that it would provide the appropriate transparency, parametric risk control and portfolio construction functions across underlying funds. We show how a FoF utilizing this kind of distributed risk budgeting framework would have a distinct advantage over those not implementing such an approach, and we further show how FoFs utilizing the architecture are, in effect, ‘virtual multi-strats’ with the added advantage of having diversified business and other idiosyncratic fund risk.

We conclude with a brief summary of the concepts discussed, and a review of the architecture proposed and the benefits provided.

Fund of funds need to become virtual, distributed multi-strategy funds, if they are to prosper and scale going forward.

If this is accepted, then we must understand that the architecture (both technical and legal) between the FoFs and their underlying funds needs to change to allow them to achieve this goal (to the mutual benefit of both the FoF and the hosted finds). The specific requirements for such a distributed risk-budgeting architecture are discussed next.

Requirements for FoF Risk Management, To Enable a ‘Virtual, Distributed Multi-Strat’ Approach

The main requirements are as follows:
1. Funds must adopt a common risk taxonomy that enables transparency without compromising individual positions in the portfolios of the underlying funds. The slogan is ‘risk transparency, not position transparency’. This taxonomy must have strong explanatory power (see below) and be used consistently for risk budgeting, risk reporting, and performance attribution.
2. The fund-of-funds must be able to participate actively in setting the risk budget for the underlying funds, including at least volatility targets, liquidity constraints, correlation targets (of returns to key risk factor ‘indices’) and leverage (of all types).
3. Multi-fund portfolio optimization must be supported, along with whatever legal and financial structures make the fund comfortable with providing each FoF client (potentially) with its own distinct ‘account’, the behavior of which has been conformed for optimal portfolio, rather than local fund, contribution.

Very importantly, each of these goals must be satisfied as a ‘win-win’ proposition between the FoF and the underlying funds, otherwise the chance of adoption is slim. As a further requirement, any technology developed should be able to be deployed straightforwardly within a fund's infrastructure. Anything overly invasive is unlikely to work. Also, any solution must be cognizant of the fact that the distribution of fund risk budgeting will range from elementary to extremely sophisticated, and therefore the capabilities supported by a set of underlying funds are likely to be heterogeneous, rather than homogeneous.

Let us now consider each of the three requirements in a little more detail.

Transparency

Clearly, just as sound financial management requires standards for disclosure and representation of information, so effective risk management, particularly between disparate hedge funds, requires a standardized, detailed and transparent approach if it is to function successfully. However, there is no ‘US GAAP’ for hedge fund risk reporting. A central point of contention regarding transparency turns on the question of position disclosure. Should funds be forced to reveal their holdings, in real time, to their investors (a practice referred to as position transparency)? The industry has generally pushed back against this, and understandably so:
Many investment strategies, particularly shorts, are vulnerable to direct predation if disclosed. For certain approaches, such as global macro, even detail buckets (such as detailed geographic breakdowns) may reveal too much.
As a related point, quantitative approaches risk having their edge ‘back solved’ from the trading logs, particularly stat arb funds that trade heavily and therefore provide many data points for potential predators to number crunch.

Not are the advantages of position transparency that clear-cut from the FoF's point of view:
Data≠understanding. The individual positions do not constitute in any sense an explanation of the risks being run by the underlying fund. To achieve this, a lot more processing work must be done by the FoF. This represents a cost load that is (inefficiently) currently taken by each sophisticated FoF individually; there is no standardization or economy of scale across the industry.
Additional information is required to understand the ex ante expectations of a fund with respect to its positions, in many strategies. For example, knowing that a fund is taking a ‘long target short acquirer’ position within a merger arb strategy does not, by itself, quantify the manager's belief about the event risk on the deal.
Position transparency is not sufficient to describe risk. For example, it does not address all aspects of leverage.
Pragmatically, something less than 50% of hedge fuinds will accept position disclosure, and there is evidence that by insisting upon it, a FoF will be implicitly tilting their investment universe towards weaker funds (Horwitz, Hedge. Fund Risk Fundamentals, op. cit.)
Increasing vigilance by investors in seeking ‘most favorable thus-granted terms’ means that funds are increasingly uncomfortable about providing side-letter position transparency to certain investors, and are moving instead towards a standard that they can comfortably live with across for all investors.

It is little surprise then, that essentially all serious studies that have looked at this market have concluded that position transparency is fundamentally non-viable. For example, the Managed Funds Association report Sound Practices for Hedge Fund Managers (2003) does not mention transparency; the International Association of Financial Engineers (IAFE) Investment Risk Committee (IRC) suggested in Hedge Fund Disclosure for Institutional Investors (2001) that “IRC Members agreed that full position disclosure by Managers does not always allow them to achieve their monitoring objectives, and may compromise a hedge fund's ability to execute its investment strategy. Despite the fact that many Investors receive full position disclosure for many of their investments, the members of the IRC who have participated in the meetings to date were in agreement that full position disclosure by Managers is not the solution”. Unsurprisingly, it is these same concerns—and ultimately lack of efficacy—that have led to the unwillingness to adopt managed accounts.

What, then, is the solution? In 2001, the Investment Risk Committee (IRC) of the International Association of Financial Engineers (IAFE) suggested the following (Investor Risk Committee of the International Association of Financial Engineers, Hedge Fund Disclosure for Institutional Investors):
IRC Members agreed that the reporting of summary risk, return and position information can be sufficient as an alternative to full position disclosure. Such summary information should be evaluated on four dimensions: content, granularity, frequency, and delay. [ . . . ]
Regarding content, the IRC was in agreement that:
   VaR can be useful information but should be calculated using an industry-standard definition. [ . . . ]
   Aggregate measures of a fund's exposure to different types of asset classes can be useful. [ . . . ]
   Aggregate measures of a fund's exposure to different geographic regions can be useful. [ . . . ]
   Net asset value (NAV) and stress measures of NAV appropriate to the strategy can be useful [ . . . ]
   Cash as a percentage of equity can be useful. [ . . . ]
   Correlation to an appropriate benchmark can be useful. [ . . . ]
   Delta, gamma and other measures of optionality, as appropriate, can be useful. [ . . . ]
   Key spread relationships, as appropriate, can be useful. [ . . . ]

As a response, proposals for risk management systematization (such as the Risk Fundamentals product from Kenmar) have been created, and other systems (such as the RiskMetrics product from the RiskMetrics group) have been extended. We examine these developments in more detail below. Generally, such systems operate by providing explanatory measures of risk (e.g. orthogonalized risk factors across primary market ‘indices’ and secondary market elements; for example, the parallel curve movement around the 5-year point as the primary index for interest rates, with curve twists, butterflies etc forming the secondary sensitivities). Generally, this type of approach is useful, as it allows risk to be communicated in a standardized manner that does not requite full position transparency, but only the exposure of factor-based sensitivities (an approach referred to as risk transparency).

In summary, we contest that for FoFs to be successful going forward, they must adopt (and to some extent impose on the funds in which they invest) a standardized methodology for communication of risk, which:
Covets at least the major dimensions of risk: liquidity, leverage, volatility (of fund return) and correlation (of fund return to standardized, explanatory, risk factors).
Ideally covers also geographic sensitivities, concentrations etc.
Is able to cope with non-linear instruments, and particularly, when stress testing, is able to cope with the fact that simply projecting from e.g. the delta and gamma of an option, does not lead to an accurate result, where the moves are large.
Is focused on risk transparency, rather then position transparency, the latter being an unrealistic and often counterproductive goal.
Is utilized in a consistent manner for ex ante risk budgeting, current portfolio construction risk reporting, and ex post performance attribution.
Is able to operate within an absolute returns methodology, or an indexed methodology, as desired.
Is recursive, in that a FoF should be able to generate its own risk profile in identical format to those of the contributing funds.

Active, Parametric Risk Control

The next key requirement is for active, parametric risk control. By this we mean that the FoF should be able to not only participate in passive allocate-execute-report-optimise-allocate cycles (see page 3), but also be able to set the goals for the risk budgeting engines of its underlying funds ex ante.

Now, it is clear that the sophistication of funds towards risk budgeting will vary greatly. Some will take a very basic approach, for example simply capping risks that are too extreme (perhaps by imposing maximum position size limits) and otherwise, letting the chips fall where they may. However, more advanced funds will actively seek to manage their risk budget, trying to ‘spend’ each unit of risk (in whatever dimension) in an optimal fashion. This is particularly so of advanced systematic trading funds, which explicitly estimate risk budgets ex ante, across multiple dimensions of interest.

It seems reasonable that a FoF investor should be able, to some degree, to participate in setting the risk budgeting parameters for the funds in which it is invested. After all, setting or at least constraining a risk budget is a different thing from trading optimally within that budget, which is the fund's expertise and which ought to be its mandate. This is related to the final point, discussed next, that a risk management solution should allow FoFs to aggregate their invested funds together into an optimal portfolio—which may involve setting risk budgets that are sub-optimal from the perspective of any given fund when considered alone.

Multi-Fund Portfolio Optimization

The main threat to FoFs in future, as previously described, comes from aggressive multi-strats (such as Millennium Partners LP, Renaissance Technologies Corp. etc) which are able to offer much more rapid and multi-dimensional risk budgeting within a single layer of fee overhead. A secondary threat (where FoFs act only as passive aggregators of underlying investments) is that they will be priced out by ‘tracker’ products, or by institutions (such as pension funds) performing their own aggregation functions without the additional fee layer.

We contest that, in order to compete against such pressures, and provide genuine justification for additional fees, FoFs in future will have to become much more ‘distributed, virtual multi-strategy funds' than they currently are. For this to be achieved, additional technology and legal architecture between FoFs and their underlying funds is required. We shall first briefly review why a portfolio-level approach is required, and then why support for such an approach requires additional development.

The Value of a Portfolio-Level Approach

Currently, FoFs essentially rely on funds to carry out the following functions:
1. To set their own risk budgets, and not to deviate from these (i.e. to avoid style drift).
2. To execute their strategy efficiently within these risk budgets (provide alpha).
3. To report performance attribution and current position risk stances with some semblance of detail and timeliness.

As we have pointed out above, function 3 should be standardized between funds, with much greater risk transparency provided. Function 2 is clearly the point of the fund, in fact its whole reason for existing. Function 1, however, is much mote interesting. There are two issues:
It is sensible for FoFs to be able to have some input into the risk budgeting of their underlying investments, much as major corporate shareholders often impose some degree of financial oversight and budget management on their investments (think, in particular, of the role VCs play on the boards of companies in which they invest).
While it is sensible to rely on funds to perform trade netting etc. to lower risk within the ambit of their expertise, currently individual funds are also motivated (through the management and incentive fee structure) to generate the best individual local) fund performance that they can, commensurate with risk small enough to keep FoF dollars rolling in. The problem with this is simple: what is best for an individual fund's risk adjusted performance, does not necessarily make that fund the best possible portfolio addition for a FoF. This is a fundamental issue.

It is entirely possible that funds, due to their construction, hedge out e.g. secondary risk factors, while in a portfolio construction one would rather hedge primary factors first. The order of fund construction matters, and the best global optimization is not necessarily created by aggregating a series of locally optimized funds. This is formally provable, but a simple example may serve better to get the point across.

Consider a simple (Markowitz) world in which there are four instruments (which may be thought of as the result of pursuing four different trading strategies), termed A, B, C and D. In this world, there are two funds F1 and F2, seeking to obtain maximum economic benefit for themselves through a combination of management and incentive fees. However, F1 can only ‘invest’ in A & B (i.e., can pursue internally different, non-negative amounts of the strategies whose return profiles are encapsulated in the conceptual instruments A & B) and F2 can only ‘invest’ in C & D. As we shall see, their locally rational optimization actions are not necessary best for FoF1, a fund-of-funds in this world that is seeking to combine optimally non-negative allocations to F1 and F2.

We assume for simplicity in this example that A-D are normally distributed and so may be represented by their expected mean and covariance matrices. Let us assume that the mean (annualized) expected returns from the strategies are as follows:

| | Annualized | Annualized | Sharpe Ratio |
|---|---|---|---|
| Trading Strategy | Return | Volatility | (2%) |
| A | 13% | 12% | 0.917 |
| B | 15% | 15% | 0.867 |
| C | 15% | 11% | 1.181 |
| D | 14% | 12% | 1.000 |

Assume that the correlation matrix is as follows:

$${corr}_{i , j} = ( \begin{matrix}1.00 & 0.40 & 0.55 & - 0.10 \\ 0.40 & 1.00 & 0.01 & - 0.45 \\ 0.55 & 0.01 & 1.00 & 0.50 \\ - 0.10 & - 0.45 & 0.50 & 1.00\end{matrix} )$$

From this and the annualized volatility, we can generate a covariance matrix as below:

$${σ}_{i , j} = {corr}_{i , j} {σ}_{i} {σ}_{j} = ( \begin{matrix}0.0144 & 0.0072 & 0.0073 & - 0.0014 \\ 0.0072 & 0.0225 & 0.0002 & - 0.0081 \\ 0.0073 & 0.0002 & 0.0121 & 0.0066 \\ - 0.0014 & - 0.0081 & 0.0066 & 0.0144\end{matrix} )$$

Calculating the locally optimal A&B and C&D strategies, we would use the top left 2×2 elements and the bottom right 2×2 elements of this matrix, respectively. If we now use a conventional portfolio optimizer to look for the highest Sharpe ratio (assuming a 2% risk free rate) portfolio for F1 (the A&B fund), we find that the optimal balance (which, being a rational fund and wishing to generate maximum fees, they would therefore execute), is as follows (this was computed using MATLAB, with an optimization set to find only the highest Sharpe ratios (for simplicity, risk aversion has not been used in this example; simple optimal Sharpe search along the efficient frontier was used). The solution was constrained to disallow borrowing or short selling):

| Trading Strategy | Portfolio Allocation |
|---|---|
| A | 58.8% |
| B | 41.2% |
| F1 Portfolio Expected Return | 13.8% |
| F1 Portfolio Expected Volatility | 11.1% |
| F1 Portfolio Sharpe Ratio (2%) | 1.07 |

Unsurprisingly, ‘A’, which has the higher instrument Sharpe ratio, gets the larger allocation. It is a similar story for fund F2 (the C&D fund), whose optimal balance is as follows (again, unsurprisingly, the better performing strategy C gets the higher allocation):

| Trading Strategy | Portfolio Allocation |
|---|---|
| C | 64.5% |
| D | 35.5% |
| F2 Portfolio Expected Return | 14.6% |
| F2 Portfolio Expected Volatility | 9.9% |
| F2 Portfolio Sharpe Ratio (2%) | 1.27 |

The fund-of-funds, FoF1, can then only combine these ‘pre-prepared’ portfolio constitutions together—although it can blend F1 and F2 in any proportion desired in its portfolio, it has lost the ability to set the ratios A/B and C/D. The covariance matrix of the two fund ‘instruments’ F1 and F2 is as follows (the covariance of the sub-portfolio is found by taking the overall weights matrix for the two portfolios (a 4×2 matrix), which we may term w, and then computing w’×σ_{i,j}×w, where σ_{i,j} is the original covariance matrix):

$${σ}_{i , j} = ( \begin{matrix}0.0123 & 0.0013 \\ 0.0013 & 0.0099\end{matrix} )$$

Performing an optimization on the F1/F2 portfolio gives the following outcome (when mapped to holdings of underlying A, B, C and D strategies):

| | Effective |
|---|---|
| Trading Strategy | Portfolio Allocation |
| F1 | 41.8% |
| F2 | 58.2% |
| A | 24.6% |
| B | 17.2% |
| C | 37.5% |
| D | 20.7% |
| FoF1 Portfolio Expected Return | 14.3% |
| FoF1 Portfolio Expected Volatility | 7.8% |
| FoF1 Portfolio, Sharpe Ratio (2%) | 1.57 |

However, looking at the 4-way correlation matrix shown above, it is clear that this portfolio is probably not globally optimal—it does not, for example, make best use of the negative correlation between strategies B and D (which have a −0.45 correlation and therefore significant diversification benefit). The net result is that an optimal global weighting should allocate more heavily to B and D, not the locally optimal A and C. Running the equations for the global scenario (where FoF2, through an appropriate mechanism, is able to influence the funds F1 and F2 to use different allocation decisions locally, which are better for FoF2 in a global context), we achieve the following results:

| | Effective |
|---|---|
| Trading Strategy | Portfolio Allocation |
| A | 13.7% |
| B | 34.0% |
| C | 3.3% |
| D | 49.0% |
| FoF2 Portfolio Expected Return | 14.2% |
| FoF2 Portfolio Expected Volatility | 6.6% |
| FoF2 Portfolio Sharpe Ratio (2%) | 1.84 |

The FIG. 2 diagram shows how the optimal global strategy exceeds the ‘best efforts' aggregating strategy.

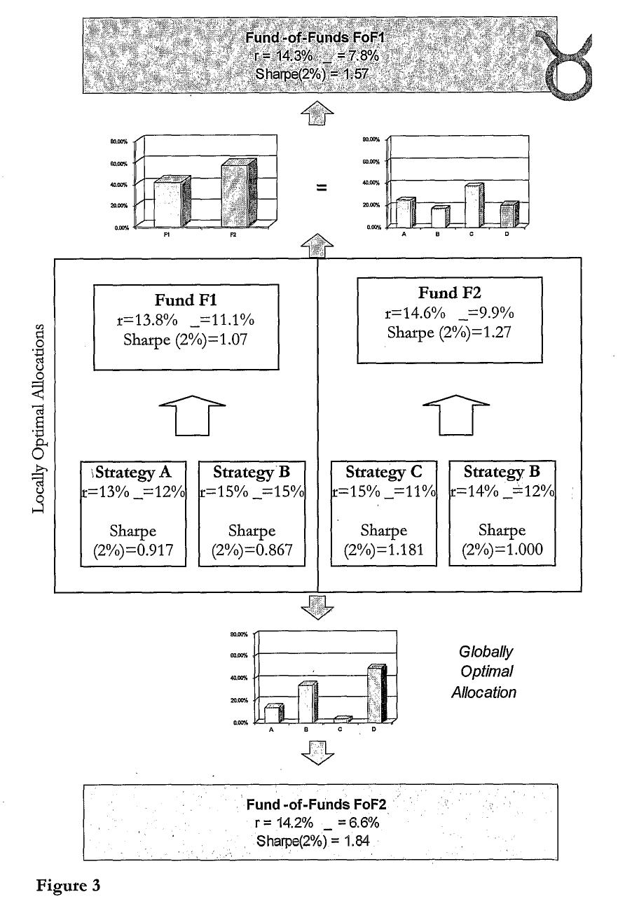

This situation may be summarized as follows: aggregating locally optimal portfolios does not, in general, produce a globally optimal portfolio (even in our very simplified Markowitz world). The outcome of out little thought experiment on optimization is illustrated in FIG. 3.

Of course, there is a downside to this approach for the funds involved. Ignoring the relative amounts in total that are optimally invested with each fund (since that is an issue even in the case of the aggregator, FoF1, and a fund cannot complain about a counterfactual investment!), and the extent to which this may move over time, they are still rewarded on their local performance. Therefore they will (in effect) be penalized if they support the FoF with a local account within which they enable selection of the ‘optimal’ asset allocation, as FoF2 would require.

A Portfolio Approach Requires Modified Structuring

To quantify this, let us assume that the allocations to each fund in total are not a point of contention. For simplicity, let us also assume that we are only interested in a single period (say, 1 year) and that compounding beyond that period is not considered.

Then, the implication for funds F1 and F2, following the ‘optimal’ weighting for FoF2 (for example, in a special managed account), compared with what they would have received had the money been invested outright, is as shown below (this assumes that money can be borrowed or invested at the 2% tisk free rate (for simplicity), and that the volatility of the portfolio is normalized to that of the original portfolio, to make the results (in terms of risk-adjusted return) commensurate):

| | | Annualized Return | | |
|---|---|---|---|---|
| | Annualized | using Globally | | Incentive Fee |
| | Return using | Optimal Weights, | Difference | Shortfall |
| | Locally | Adjusted to | in | (Assumes 20% |
| | Optimal | Equal Locally | Annualized | Performance |
| Fund | Strategy | Optimal Strategy's | Return | Fee) |
| F1 | 13.82% | 13.04% | −0.79% | −0.16% |
| F2 | 14.64% | 12.32% | −2.32% | −0.46% |

Assuming that F1 and F2 are both running capacity-limited strategies, and assuming that there are other investors willing to take their base product, it is clear the F1 and F2 are not incentivized to assist FoF2. This is particularly true for F2, which will lose an estimated _% per capacity unit in fees per year. Given that a fund making 15% per year on a ‘2 and 20’ fee structure has an expectation of 2%+20%*15%=5% per capacity unit, a loss of _% is highly significant (10% drop in expected fees).

Because of the economics just outlined, we claim that any approach to moving to a ‘virtual multi-strat’ approach will be resisted by funds, unless the potential for local performance degradation is dealt with. Current legal arrangements between fund-of-funds and their underlying investments do not address this issue, which is why a portfolio approach to risk budgeting requires modified compensation structuring to succeed.

A Portfolio Approach Requires Technology Support

There is currently no way for investors in funds (even sophisticated FoFs) to participate in the risk budgeting/optimization of those funds. If funds allowed further risk transparency, this would assist to some degree—but note that they would have to report on the risks of their component strategies etc., and not simply that of the composite fund—otherwise the FoF would gain only a better understanding of the shape and magnitude of the fund's risks (which is good), but not, critically, an understanding of the points of articulation available to the fund for management of those risks (which would be better).

Furthermore, sophisticated risk management generally involves optimization of a non-linear multi-variate objective function, and the objective function may contain steep gradients (e.g., due to derivative instruments held in the portfolio). However, most funds that use risk budgeting currently 1) optimize primarily using Markowitz mean-variance analysis at a formal level, with other risk exposures (to the extent that they are considered) being managed in a more informal manner—in other words, funds in general do not have sophisticated risk optimizers capable of working in a nonlinear, multi-variate objective function space. Therefore, there is a need for additional software to enable funds to participate in that kind of decision making and 2) funds are not currently running optimizers that enable the objective function to be optimized across funds (in a secure manner) rather than on a purely local basis. Therefore, there is a requirement to provide this networked capability to funds within any risk management system that is supplied.

A Recap and Caution!

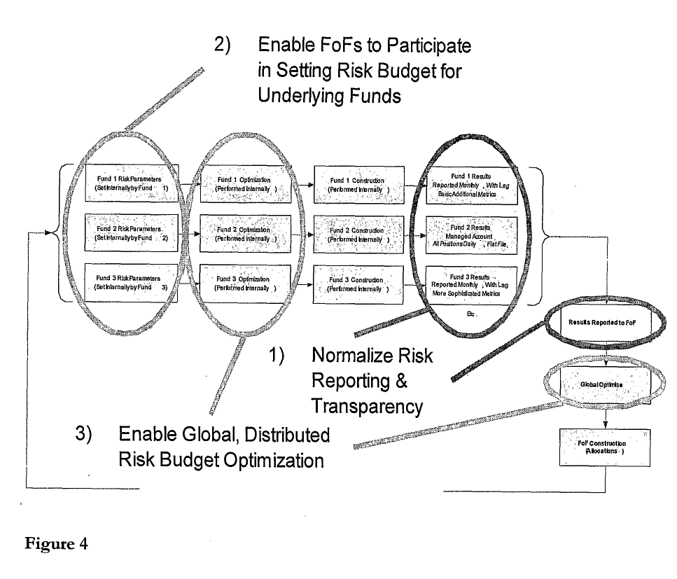

In this section we have considered the three primary requirements for a next-generation risk budgeting system, which would enable FoFs to compete effectively against multi-strats. These are shown in FIG. 4.

In summary, it is vital that:
1. Funds implement risk transparency on an multi-factor risk model (not simply VaR etc) and use this taxonomy internally for risk budgeting (ex ante), risk reporting, and performance attribution (ex post) analysis.
2. FoFs gain access to influence or set explicitly the risk budgets (against this richer taxonomy) for their underlying funds.
3. Funds support the ability to optimize a non-linear portfolio of instruments across multiple, independent funds (without loss of security) and are capable of optimizing against a complex objective function.

We also reviewed a simple example to show why local optimization of risk, while rational for the funds performing it, can lead to sub-optimal global performance when aggregated. Multi-strats do not have this problem and this fact, coupled with their single tier fee structure, means that they will increasingly threaten FoFs going forward.

However, a caution should be sounded regarding the example. It only looked at mean variance analysis, not multi-variate risk exposures (e.g., to equity indices, bond indices, etc.), and posited a situation where two strategies used by separate funds had high negative correlation to each other. It is not difficult to find problems with this:
Mean variance analysis, in general, is not a sound basis on which to optimize, since although covariance shifts (in general) slowly over time, return series have lower serial autocorrelation (i.e., they are much less predictable, so using historical returns as the basis for future predictions is not entirely sensible).
We assumed in the example that a fund perfectly hits its target mean return at the target volatility (this is unlikely in practice). However, it is reasonable as a discussion of expectation.
The negative correlation shown is an extreme case. However, when one starts to look at other dimensions of risk, such as the beta to e.g. bond indices, then it is perfectly possible to find risk pairings in diverse strategies between funds. Furthermore, the ability to neutralize this exposure may be of crucial importance to one FoF, and a matter of supreme indifference to another.
Funds may often expose individual strategies (such as A, B, C and D) as standalone funds, rather than (or as well as) aggregating them. Nevertheless, there may be many situations in which, when optimizing against a larger multidimensional risk target, different funds do hedge away exposures internally in a sub-optimal manner, or make trading choices that are globally sub-optimal (e.g. risk arbitrage traders all attempting to trade the same ‘best’ deals, rather than having some trade the somewhat sub-prime trades as a diversifier).

Despite all this, as an allegory the example still serves a useful purpose, provided one does not take it too literally!

Next, we will briefly review the Risk Fundamentals system, which comes closest as regards current art to satisfying the first of our three requirements (although not, as we shall see, entirely, and it does not provide a solution to the other two).

Brief Review of the Risk Fundamentals System

The Risk Fundamentals system is a risk reporting and analysis system (see Horwitz, Hedge Fund Risk Fundamentals, op. cit) that aims to solve the ‘transparency’ dilemma, by defining a set of standard risk categories and algorithms to be used by hedge funds and which allows an ‘explanatory’ view of risk to be provided (risk transparency) to investing FoFs, without requiting full position transparency. Risk Fundamentals was developed by Richard Horwitz at Kenmar.

The main components of the Risk Fundamentals system are as follows:
Risk factors: e.g. equity risk factors broken down into seven style factors (value vs growth, large cap vs small cap etc) for each country and twenty-four GICS (global industry classification standard) industry risk factors. Risks are calculated as sensitivity to risk factors. Sensitivities are additive. Idiosyncratic risk is checked for cross-correlation (e.g. to detect an as-yet-undetermined-but-present explanatory variable, such as tech in the bull market to 2000)
Fund subsystem: for managers. Provides measures of liquidity, concentrations, and risk-factor sensitivities. Creates historical simulation, performs normal+stress market analysis. Allows ‘slice and dice’ of risk. Calculates standard hedge fund stats (Sharpe etc) plus provides ‘what-if’ analysis for different constructions and measures of marginal risk and marginal risk adjusted returns, plus an optimiser.
Transparency subsystem: allows secure distribution to investors of risk profiles of underlying managers, individually or aggregated.
Investor subsystem: similar to fund subsystem, but for investors. Sophisticated optimiser. Allows fund-of-funds to aggregate underlying risk and offer compound result to its investors in an identical format (so one could create a fund-of-funds-of-funds!)
Performance attribution subsystem: Analyzes performance of prior portfolios and uses risk factors to attribute returns as beta to market, style exposure, value added in sector or industry selection, active management of structural risk, and security selection (e.g. stock picking). Available to both managers and investors.

Risk Fundamental statistics are aggregated across funds to provide rankings, and are also used to calculate standard indices that communicate norms (and how these change over time). Screens can be applied against the rankings to select funds (e.g. top 25% in leverage).

A hierarchical approach also means that hedging instruments can be included in a portfolio (as well as making funds and fund-of-funds commensurate. Absolute and relative measures of risk are supported. Custom assumptions can be ‘toggled on’ for local analysis (common assumptions are used for standardization).

The multi-dimensional optimization approach utilised by Risk Fundamentals is the subject of a U.S. patent application (Ser. No. 10/373,553), although the concept of performing a orthogonalized risk factor reduction, taking the most explanatory risk factors first, is well known and applied by many companies such as BARRA. In this kind of approach, market risk (e.g. correlation to the curve shift in fixed interest, to the S&P in equities, etc) is considered first, and linear regression to the specific market index is made and then the residuals computed. One then proceeds to analyse these residuals in a similar manner with the secondary risk factors (e.g., curve twists and butterflies for fixed income, equity styles (large cap etc) for equities).

More sophisticated approaches (such as factor rotation to generate explanatory models) are also disclosed in the public domain prior to the priority date of the Risk Fundamentals application, and therefore the patent filed seems to have relatively little substance. It has not yet been examined in the US.

Overall, the Risk Fundamentals system is a creditable attempt to deal with the problem of creating a lingua franca for risk reporting. The system does have drawbacks, however, which are:
Stress testing only has the basic ‘greeks’ to work with, so when a large move is simulated in the underlying risk factors, the simulated result (being just a delta+gamma extrapolation) will probably be inaccurate. This is particularly important for options that are close to expiry and where the underlying is close to the strike, as their gamma can change radically with relatively small moves in the underlying.
Sophisticated path-dependent derivatives are not supported (the system is based upon applying a historical simulator to current risk factors, and because it does not utilize a parametric or Monte Carlo methodology, cannot analyse instruments that are not well described by a relatively simple approach).
The system is only partially built, and has a strong focus on equities. Many of the features described in Horwitz's book are not currently available.
It is unclear that calibration of e.g. event risk from credit spreads, as suggested in the Risk Fundamentals book, is entirely straightforward (this is a good example of a ‘not yet implemented’ feature).
The risk analysis does not support the use of trading strategies as virtual instruments (this is an important limitation for systematic funds in particular).
The system contains an optimizer, but due to its construction (constraint-based linear programming) it is incapable of dealing with complex objective functions with a highly convex codomain.
The optimizer does not support distributed cross-fund optimizations.
Linear regression is used as a primary attribution methodology.

In short, the Risk Fundamentals system provides a relatively strong basis for common risk reporting (provided the paradigm of historical simulation against linear orthogonalized risk factors is deemed of sufficient power, which it often is not), however, it does not provide a sufficient basis for a distributed, active, risk budgeting solution—a different approach is required.

A Brief Word About RiskMetrics

It is a similar situation with the RiskMetrics system—good for reporting, but with little support for active risk budgeting (see Jorge Mina and Jerry Y Xiao, Return to RiskMetrics: Evolution of a Standard (RiskMetrics Inc., April 2001). The RiskMetrics system does support the use of Monte Carlo simulation, but has some other drawbacks—it does not provide a very detailed risk analysis (being centred around risk attribution to four major markets only—equity prices, foreign exchange rates, commodity prices and interest rates). Secondary factors and the credit spread and real estate markets are not (in general) represented. Furthermore, the focus is on representing the VaR contribution of each portfolio instrument, which tells little about such other important factors as liquidity, sources of leverage etc. Furthermore, VaR is not a subadditive measure of risk. As a conclusion then, while the RiskMetrics approach has many strengths, the primary disadvantage from a risk reporting point of view is the loss of useful explanatory power through the representation of many contributory elements of exposure in a (too-small) set of risk factors, and ignoring other elements of risk (such as liquidity etc.) altogether. Furthermore, the RiskMetrics approach, just as is the case with Risk Fundamentals, does not support active risk budgeting or distributed portfolio optimization across multiple funds.

Crescent's RiskBLADE architecture is designed to address these shortcomings and provide a complete solution for next generation fund-of-funds. We will now turn to describe the RiskBLADE product in more detail.

Description of the RiskBLADE Architecture

RiskBLADE is a set of ‘plug in’ technologies that has been developed to enable FoFs to operate in a ‘distributed, virtual multi-strat’ model with respect to their underlying funds. The RiskBLADE architecture expressly addresses the three requirements that have been developed in some depth throughout this document. RiskBLADE is a modular system that is composed as follows (we will describe each of the components in mote detail shortly):
A descriptive risk factor model that expresses leverage, liquidity, return volatility and correlation to key indices (in an orthogonalized fashion). Common descriptions of risk are used ex ante for risk budgeting, and ex post for performance attribution.
A risk factor response API (application programming interface—a template against which software is constructed) for individual instruments. Each instrument in a portfolio is exported as a component that responds to this API, enabling the simulation of complex derivatives and highly non-linear objective function codomains. This is distinct from systems such as Risk Fundamentals that treat the risk exposures as constructive, not simply descriptive. Exported instruments are still ‘opaque’ in that their identities are not disclosed and nor are they inferable, so the API provides a tool for risk transparency, without requiring position transparency. Trading strategies (for systematic funds) may be used as ‘virtual instruments’, providing much better forward risk simulation. The API is a Microsoft .NET distributed interface, and a set of adapters for MATLAB is also provided.
A portfolio construction system for funds that enables the creation of aggregates of instrument objects supporting the API. No programming knowledge is required, therefore, to create a portfolio of compliant instrument components on behalf of participating funds.
A distributed optimization system that enables a set of candidate portfolio construction (expressed as a set of exported software components supporting the RiskBLADE instrument API), to be optimized against a user specified objective function (again, expressed as a software component within the FoF operating to a provided API). Because the optimization system is networkable (distributed), it becomes possible to ‘hook up’ the instrument components from multiple funds into a large, single ‘virtual’ pool for manipulation by the optimizer, without this compromising the position confidentiality of those individual funds.
A risk transparency and performance attribution system that allocates actual performance against the various domains of risk and then allows this ex post data to be contrasted with the ex ante expectation. This performance attribution subsystem is also capable of generating (using standardized algorithms) the usual performance metrics for funds (e.g. Sharpe, Sortino, rolling-x-month correlations, VaR, etc.) and of building this into an electronic ‘fund sheet’ that can be updated on as frequent a basis as is desired by the fund (up to and including daily updates, if needed). Risk descriptions provided do not include position transparency (although this can be provided should the underlying manager permit).
A stress testing subsystem that allows a portfolio to be subjected to extreme events. These events can either be based upon historical data (such as the 1998 LTCM/Russian Crisis, in which a flight to quality caused assets that were not normally highly correlated to become much more so, and corporate credit spreads to widen greatly), or upon risk-factor configurations that are deemed to be possible and worthy of consideration by the utilizing FoF.
An ‘optimization cost’ analysis and fund relationship, that enables an invested fund to provide a special ‘segregated account’ for a FoF, in which the latter can contribute to setting the risk budget. There can then be put in place an ‘alpha swap’ between the fund and the FoF, whereby the fund is compensated for lost performance (if any), but the FoF still gains significant benefit due to the 20%/80% split in performance attribution. The use of alpha swaps is not in any sense mandated, however!

The RiskBLADE architecture will allow FoFs to create a distributed virtual multi-strat without the need for underlying funds to provide position disclosure. Let us now step into each of the points above in more detail, so that the main elements of the architecture may more clearly be understood.

A Descriptive Risk Factor Model

The primary risk analysis perspective of RiskBLADE is to require a fund to be able to characterize, for a given portfolio construction, its exposure along a number of important dimensions, specifically:
Leverage: description of the amount of financial leverage and portfolio diversification that is achieved. Financial leverage is broken out into borrowing leverage and notional leverage (and this is then specified as leverage specific to futures, options and other derivatives).
Liquidity: description of the portfolio's required time to liquidate against % of portfolio liquidated.
Volatility: description of the return volatility of the portfolio, and the degree of higher-moment effects (skew, kurto sis etc.) present, together with a breakout of upside and downside volatility.
Correlation: breakdown by major markets of the correlation (marginal sensitivities) of the risk of the portfolio to the six major markets and sub-factors within those markets, together with an sub-attribution to secondary factors within those markets, and an analysis of the final residuals (theoretically, this should be purely idiosyncratic risk, but in fact there may well be internal ‘structure’ to the remaining idiosyncratic risk, such as internal correlations, that suggest a potentially explanatory risk factor is missing).

The concept of multi-factor analysis has been utilized in other approaches (for example, Risk Fundamentals, BARRA, and to a lesser extent, RiskMetrics). The general approach is to perform an orthogonalized decomposition of risk, looking at the most explanatory variable first, fitting (generally linearly) the risk factor to this and then generating the residuals for the subsequent analysis.

RiskBLADE uses the following risk factors for analysis (these may be thought of as ‘risk adjusted return betas' to the specified markets:
Equity markets: beta to S&P 500
   Secondary—correlation of residuals to style (large cap etc.)
   Secondary—correlation of residuals to industry group
   Secondary—correlation of residuals to equity volatility (VIX and actual)
   Secondary—country specific risk
Interest rates: beta to US treasury actives curve 5 year point
   Secondary—correlation of residuals to (long bond-5 year) spread
   Secondary—correlation of residuals to (1 year-5 year) spread
   Secondary—correlation of residuals to interest rate volatility (measured at 5 year point)
   Secondary—country specific risk
Credit spreads: beta to spread between mid-grade corporate bonds and treasuries
   Secondary—correlation of residuals to high-grade corporates
   Secondary—correlation of residuals to low-grade corporates
   Secondary—correlation of residuals to credit spread volatility (measured by mid-grade spread volatility)
   Secondary—country specific risk
Commodities: beta to CRB index
   Secondary—correlation of residuals to major commodity groups. These may be viewed at a number of different maturity horizons if desired.
   Secondary—correlation of residuals to CRB index volatility
Currencies: beta to US dollar index
   Secondary—correlation of residuals to individual currency majors
   Secondary—correlation of residuals to US dollar index volatility
Real estate: beta to REIT proxy

There is also the question of exposure to event risks, for example the potential of a corporate default, or of a merger deal failing to close. Attributions to these risk factors should certainly not be claimed as idiosyncratic, and yet it is difficult to systematize an approach to capturing them. We aim to create an event risk capture within the system (e.g., treating a corporate's credit spread as a potential indicator of its likelihood of default) going forward; it is not currently supported.

The final residual of all these attributions (the putative idiosyncratic risk of the portfolio) is then subjected to further analysis to ensure that it has a normal distribution structure and no internal correlations (which would suggest a potentially explanatory risk factor that was missing from the list provided).

Attributions to these risk factors for a portfolio are provided as part of the risk reporting (risk transparency) regime—in this way good explanatory power of the sources of a portfolio's returns (and exposures) may be generated for investors (FoFs) without requiring full position transparency. The same risk factors are utilized during performance attribution as during initial ex ante exposure attribution. In this regard the system has a similar approach to Kenmar's Risk Fundamentals system.

However, a key differentiator here is the use of active instrument modules. This means that the RiskBLADE system calculates exposure to factor sensitivities through 1) asking each instrument to provide its derivative to that factor, if available and 2) carrying out Monte Carlo simulations against a varying background of risk factors with each instrument. Simulation against historical conditions (the basis of the Risk Fundamentals system) may also be used if desired, but this approach has serious drawbacks when considering analysis under stress scenarios and where derivatives are involved.

A Risk Factor Response API

RiskBLADE treats each instrument within a candidate portfolio (such as a particular equity holding, bond, interest rate future etc., or a trading strategy applied to a particular instrument) as a software component, which has to be able to respond to a particular interface, or API. Components instantiating the appropriate API may be generated automatically for ‘standard’ instruments, but portfolios utilizing more sophisticated contracts (such as options with knock-outs etc) are able to have this represented accurately by providing an implementation of the instrument themselves.

The API utilized is expressed in Microsoft's .NET programming environment, but ‘wrappers’ are provided to enable instrument code written in MATLAB also to be used. The point of mapping instruments into active software components is that his enables complex, non-linear behavior to be represented. An instrument's component proxy can ‘respond’ (through its API) to queries that ask how the instrument's price would change in response to a modified environment (described as an n-tuple of the major risk factors previously disclosed). These queries do not rely upon the details of the underlying instrument itself being disclosed.

Furthermore, because of the ability to allow .NET components to interact across a distributed domain through remote procedure calls, it becomes possible to bring together a ‘virtual portfolio’ consisting of instruments from (e.g.) Fund A and Fund B, into a common domain and then perform the ‘what if’ or Monte Carlo analysis based upon this ‘virtual’ structure, while still not requiring position transparency from either of the participants.

The API supports the ability for an instrument to provide price sensitivities based upon a matrix of ‘synthetic forward histories’ of risk-factor changes (expressed as a ‘factor×time×trial’ matrix), as well as query historical correlations to risk factors for the instrument. Trials are assumed to be launched around the current state of the instrument (this is necessary to prevent disclosure of the current instrument price, and also makes sense from a simulation perspective as we generally care about the risk exposures of the instrument forward from its current state), but it is possible to set the history to a previous actual time point if desired as well as explicit price values (support for these latter two functions is optional). Note that the final ‘factor’ in this matrix is treated as the generator random variable for the trial. With a time offset of 0 for the first step and only this step in the matrix sensitivities around the current point can be generated by simulation. The penultimate ‘factor’ is treated as the generator random variable for the factor sensitivities of the instrument. The instrument may be insensitive to changes in the value of this variable or not, depending upon its structure. Note however that we are not here considering the fact that under a Monte Carlo simulation the covariances between the risk factors themselves may have a stochastic evolution. That fact is embodied in the simulator and the issued forward histories will have been created from processes that exhibit such evolving covariance, if this is required. Rather, the point is that the instrument's sensitivities (residual orthogonalized _s) to each risk factor may have a random element and this is assumed to be represented totally by the specified variable (which may be mapped, unpacked etc as required). And further, this is distinct from the residual behaviour of the instrument independent of the risk factors, which is deemed to be controlled by the second variable, again which may be mapped and unpacked as required).

The API also supports the concept of a ‘static’ query, whereby risk factor return sensitivities are assumed to be linear and stable at a given time and may therefore be represented as a ‘orthogonalized-vector’. An instrument need only support one or other of the interfaces, although it can support both if desired.

For non-linear derivative claims, there can be vast difference in the outcomes reported for multiple trials even with the same factor history under the Monte Carlo interface, but different generator-value paths (the last two matrix ‘factors’). Note that we assume that the derivatives are fully price-determined by their underlying and so the random generators are used to drive the outcome of the final residual generator for the underlying instrument, from which (together with the impact of the other risk factors) the value of the derivative claim is generated.

Query of the standard analytic greeks is also possible via the API to test convexity (effective duration is also supported as a query through this interface). It is also possible to pass in a generator interface to prevent the necessity to create and pass around vast arrays of numeric data when performing a trial.

An introspection interface is provided so that only the queries that are relevant and supported by a given instrument may be queried by the simulation engine. Also, a restricted interface allows the instrument to reveal its internal details to an authenticated client (such as instrument name, underlying, option parameters (such as strike price) etc.). Detailed geographic information is also provided via this interface. Summary geographic information (region only) is available via the public interface. It is also possible via the introspection interface to gain partial (or even total, should the policy of the underlying fund permit it) access to the underlying private interface, to enable more detailed data to be extracted.

The private interface also supports a current pricing routine. For simple instruments, this simply translates to a Bloomberg query, but for more complex or illiquid instruments, user-defined price estimation routines may be provided.

Summary data on leverage is also available for query from the various simulation interfaces.

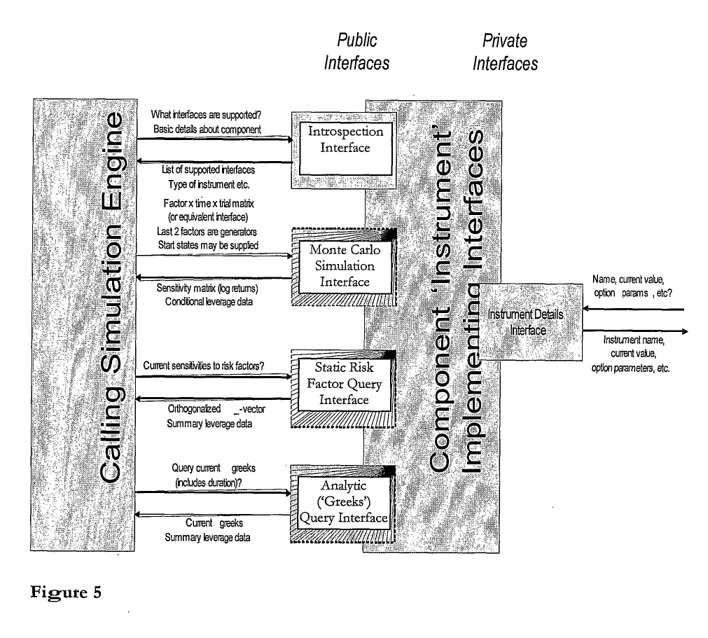

The FIG. 5 diagram shows conceptually the interfaces that are defined for an instrument:

Finally, although the API is a .NET interface (or, more strictly defined, a collection of such interfaces), a wrapper is provided to allow instruments to be created in MATLAB if desired. This makes coding more straightforward in many cases, since MATLAB is designed specifically to support matrix manipulation and is used by many quantitative trading strategies as their implementation platform.

The good news, however, is that for the majority of instruments (and portfolios), there is no need to explicitly code up components implementing particular instruments, as the RiskBLADE system provides tools to achieve this.

A Portfolio Construction System

RiskBLADE contains a tool that enables a portfolio of instruments to be created. This uses a front-end based upon Microsoft Excel in which instruments held can be specified as a list (note that the portfolio also contains the number of contracts etc, which is clearly not something that is meaningful at the level of the individual instrument API). For standard instruments, the system will automatically create the underlying instantiating components, given the basic description of the instrument from within the Excel interface. Basic instruments that are supported are:
US, Japanese and European equities (must have a valid Bloomberg ticker).
Exchange traded options on same (ditto).
Exchange traded futures (ditto).
Exchange traded government and corporate bonds (ditto).
Currency forwards with standard terms.
American or European options on any supported underlying with standard terms.

Certain directly supported instruments, such as OTC options on futures, require that additional information (strike, expiry etc) be provided to create the appropriate component. For others, only the Bloomberg ticker is required (all data is then fetched from Bloomberg as required). In all cases, the number of contracts held is required. Note that other instruments (real estate, MBOs, CDOs, swaps etc.) are implicitly supported, since these can be provided as user-derived components. It is expected that the range of ‘template-generated’ instruments will be expanded in the future, either by Crescent, funds using RiskBLADE privately, or by third parties providing an appropriate plug-in into the Excel portfolio management tool.

There is one other vital point to make about the RiskBLADE architecture—it supports the concept (through the use of the API-driven instrument description) of an instrument being either a ‘simple’ holding of an underlying or derivative or the result of applying a trading strategy to an underlying or derivative. Use of the latter description of ‘instrument’ allows funds to e.g. keep control of trade sizing, while ceding allocation control to the global optimizer. Judicious use of same is also a reasonable way to capture counterfactual behavior when simulating forward. For systematic funds, this enables the path dependent trading decisions to be simulated when calculating horizon risk, which increases accuracy significantly (especially for funds that implement trend following strategies). The level of ‘instrument’ chosen by each fund must be negotiated in advance with the FoF to avoid misunderstanding.

The portfolio management tool utilizes Excel as its front end but stores the underlying data in a database (Access or SQL Server). An exportable portfolio component is then created which provides access to the total set of instruments (via their public interfaces) and the aggregation data (weights), so that total exposures can be calculated. This component is the ‘gateway’ by which the portfolio may be queried by a distributed risk management system (whether this is operating as a Monte Carlo simulator, or otherwise). Liquidity is computed at a portfolio level, based upon market turnover (that is, the percentage of the portfolio that can be liquidated by a certain time horizon) given the current instrument holdings, and the desire to capture no more that a certain percentage of each instrument's average daily trading volume).

The local ‘fund manager is also able, as part of the portfolio definition process, to specify local portfolio constraints (e.g., minimum and maximum weights for instruments, minimum and maximum desired exposures to risk factors, etc.). It is also possible to specify a range-only portfolio, which describes not a concrete scenario, where weight w₁ is allocated to instrument i₁, w₂ to instrument i₂ etc, but rather a range of potential weights wₘᵢₙ₁ . . . wₘₐₓ₁ allocated to instrument i₁, etc., with a minimum and maximum utilization of portfolio capital to non-cash. This represents a candidate locally constrained portfolio that may be used by the global optimizer (discussed below).

For the fund manager, the Excel interface provides up-to-date pricing for each of the instruments. However, it is likely that a back-office system such as TRADAR, will be used as the primary portfolio tracking tool, as while the price history of acquisition (for example) is unimportant to the current sensitivities of holding, it is important administratively. Note that ultimately, the private interfaces of the instrument components are called to provide pricing. This enables complex or illiquid instruments to implement their own pricing routines. The use of local portfolio components within the funds does support the ability for real-time (or at least end of day) mark-to-market for the investing FoFs, using a distributed interface. Furthermore, this daily mark can be usefully broken down into risk-factor allocations. We describe this in more detail later, in the section on performance attribution.

Note that it is perfectly possible, and indeed expected, that the manager may have a number of portfolios created at any one time: for example, the current ‘as is’ portfolio, and a number of ‘what if’ scenarios (possibly, generated systematically).

A Distributed Optimization System

A key aspect of the RiskBLADE system is the ability, once all underlying funds have instruments that are expressed as instrument components, and are collected together into (initially) weighted groups accessed via portfolio components, to be able to execute a distributed optimization against a global objective function and constraint set, without this requiring the underlying holding information to be revealed (e.g., instrument names, precise geographic category, etc.). Just as important, the FoF can run the optimization without having to reveal its objective function to the underlying funds.

RiskBLADE supports a number of distributed optimization algorithms, including gradient descent, genetic search and direct grid search. Local portfolio generation, and simple iteration through a local portfolio candidate set, are both supported. It is recognized, however, that possible aggregate constructions increase exponentially with multiple underlying funds, so to maintain tractability certain assumptions must be made. Generally, a globally optimal solution cannot be guaranteed (within a reasonable computational time) but a good approximation generally can be.

A tool is provided for the FoF (again, using an Excel front end) in which they are able to set a risk budget explicitly. This risk budget is expressed as:
Desired minimum and maximum exposures (orthogonalized return. βs) to each risk factor (see list on page 33, above).
Desired minimum and maximum portfolio leverage (broken out by source of leverage).
Desired minimum and maximum time to liquidate various percentages of the portfolio.
Overall portfolio volatility minimum and maximum targets.
Overall portfolio return minimum and maximum targets.
Maximum acceptable drawdowns in specified stress test scenarios.

Variables that are not of interest may be left in the state of ‘don't care’.

As mentioned previously, the local manager is also able (using the portfolio construction tool) to set identical local sub-constraints.

The steps followed generally are as follows (all of these tasks may be automated at the FoF side):
The FoF manager selects the funds that are to be contained in the portfolio. This causes the RiskBLADE controller to connect to the local management components (RiskBLADEs) in each of the funds. This will usually be performed across a network (generally, the Internet) using a secure remote procedure call protocol.
The FoF manager enters (or retrieves from store a previously entered) a menu of desired risk constraints.
The FoF manager specifies the desired objective function (e.g., highest risk-adjusted return subject to constraints).
The FoF manager specifies to the simulator any further data that may be required. For example, for Monte Carlo simulation details of the conditional covariance between the various risk factors must be provided, along with the number of sample paths etc. For a linear historical simulation, the amount of historical risk-factor data must be specified. In both cases, estimates of future risk factor returns must be provided (or this can be calculated from historical data, but doing so is not advisable as empirically, this approach has little predictive power). The RiskBLADE architecture does not currently support a fully parametric simulation mode—that is, where the risk sensitivities are analytically determined, as this has very limited applicability. However, it is envisaged that the system could be extended to support such an approach in future.
The RiskBLADEs at each fund retrieve from store the local sub-constraints, which have previously been set by the local manager. Sub-constraints may (but need not be) mapped to local portfolios.
Each RiskBLADE then loads the set of local instrument portfolios available to it. There may be as little as one concrete scenario, multiple concrete scenarios, a range-based scenario, multiple range-based scenarios etc. The most usual situation will be one range-based scenario (portfolio).
The RiskBLADEs report status data back to the global optimizer. Assuming that all portfolios and instruments are operational, and that there are no inconsistencies between the local and global constraints, then the optimization process may begin.
A distributed optimization is then executed, which involves stepping through various realizations for a given construction and risk factor evolution history, and evaluating the objective function for each realization. The results of each possible paths are then weighted by the path probability to provide the overall expectation of the objective function for that portfolio construction. Then, the portfolio construction is iterated. In a simple exhaustive search, all possible legal (global) portfolios are chosen. This clearly will provide the optimal solution (or set of same should there be no unique solution) but will consume inordinate amounts of computing power, making it unrealistic in practice. A number of alternative optimization solutions are provided however, including use of large scale algorithms (where either the objective function gradients and optionally the objective function's Hessian or Hessian sparsity structure is provided) and a genetic algorithm and a mesh-based direct search routine. The core algorithms utilize the MATLAB Optimization Toolbox and Genetic Algorithm and Direct Search Toolbox to ensure correct implementation. The RiskBLADE architecture enables these tools to work within a distributed environment. Where all funds provide only ‘orthogonalized-factor-β’ factors for their instruments, then the optimization can be performed locally at the FoF site, and only the factor data need be fetched from the remote sites.
At the end of the optimization procedure, the optimal objective function value portfolio is reported. Where there are multiple portfolios with equivalent objective functions, all are reported.

Depending upon the legal relationship between the FoF and the underlying funds, the local implementations of the selected portfolio may either be directly put into practice, or else the selected local portfolio simply made available to each fund manager as a ‘strong suggestion’ regarding future action.

Note that the process of estimating current risk is the essentially the same as that of optimization, except that the portfolio choice is fixed to represent the current construction only. Similarly, performance attribution ascribes the degree to which the actual returns were attributable to ex ante risk exposures combined with the ex post historical movement in risk factors. And finally, stress testing is similar but involves choosing i) more extreme evolutions of risk factors, which will in general not reflect likelihood as captured in the ‘normal business’ covariance matrix between risk factors and ii) in simulation, generally consider drawdown (or expected shortfall) as the objective function and note the worst case outcome from a set of realizations, as well as the path-weighted expected outcome.

A Risk Transparency and Performance Attribution Subsystem

When fund managers construct actual portfolios using the RiskBLADE architecture, these can automatically be marked to market on a daily basis, and the results reported to any owning investor (such as a FoF).

As just mentioned, this exposure is computed by taking the current portfolio construction and then subjecting it to future scenarios over the time period of interest (1 day forward, 1 week forward etc) using either historical or randomly generated progressions of risk factors (in the latter case, respecting the conditional covariance of such factors). Note that due to the fact that instruments are accessed as active components, evolving, time dependent or stochastic-β behaviors on the part of the instruments can be modeled. The portfolio exposure is then computed as the weighted expectation of the underlying instrument exposures.

This approach provides risk transparency to the FoF—which is able to see the degree of current exposure of its sub-funds and then draw principled conclusions regarding how much of this is due to e.g. equity beta, large-cap exposure, interest rate differentials etc, and how much to idiosyncratic exposure. A comparison of this data with both historical information drawn from the same fund and with data drawn from other funds (whether generally, or for the fund's peer group), enable the FoF to determine whether the risks being run by the fund are:
Acceptable at an absolute level.
Consistent with the style mandate.
Consistent within the peer group.
Relatively stable over time (little style drift).

Position transparency (providing a list of all open positions for each fund) is not explicitly a part of the risk transparency subsystem (although funds can elect to release this information if they so choose). However, the detailed risk analysis provided by the RiskBLADE system greatly exceeds that of conventional fund sheets and in principle should be sufficient for the needs of FoFs.

An additional software module at the FoF enables its individual holdings' risk reports to be aggregated into a compound report in Excel spreadsheet format. This document supports drill down and ‘slice-and-dice’ to break up risk into key components, so that the FoF manager can look at geographic exposure to Asia in two of its funds, for example. These functions all use the standard Excel interface.

Of course, specifying the current risk exposures is only one part of the problem. Funds also need to report past performance, and indeed a fund sheet is generally a combination of these two functions. The RiskBLADE architecture allows a fund to generate standard hedge-fund statistics (such as Sharpe ratio, Sortino ratio etc.) for their funds, given past performance history, and to do so in utilizing a normalized methodology. It also enables performance attribution. This is the process of ‘marking’ past fund history against risk factors and prior expectations. There are three approaches to ex post performance attribution supported by RiskBLADE:
A ‘no priors’ view. This takes the fund's returns data (which ideally is daily over a reasonable period) and performs a multiple-regression against the various risk factors (per their historical progression), to generate an average historical attribution of returns. The same can be done for the most recent period, although with a large number of factors, a relatively long time will be required to achieve accuracy of attribution.
A ‘valid priors’ view. This is used for a single reporting period (e.g. a month) and looks at the evolution of each position in terms of its returns, and the returns of the risk factors, assuming that the attributions to the risk factors ex ante were correctly descriptive. This report allows investors, such as FoFs, to establish the likely source of returns during any reporting period.
A ‘questionable priors’ view. This looks at how likely the observed attributions to risk factors for each instrument (and by aggregation, the portfolio of the fund) were in retrospect, given the returns and risk factor movements that were actually observed. This data is generally used to check the quality of the sensitivity models used within the instruments themselves.

It is important to understand that the RiskBLADE architecture supports attribution on as frequent a basis as funds are comfortable. There is no reason why this should not be daily, given that:
The updates are automatic and take place electronically, so little overhead is involved.
No position data is exposed.
Portfolios (for the most part) can be constructed simply using an Excel tool, so there is little overhead keeping portfolios up to date as positions change.

This approach once more gives FoFs a good deal more oversight than is currently the case (even for those investors with managed accounts, given that the RiskBLADE reported data is already in explanatory form and does not require further processing by the FoF to make it usable).

A Brief Aside on the Use of Trading Systems as Virtual Instruments'

While we are discussing risk simulation, there is one additional important point that should be made. The RiskBLADE architecture enables systematic funds to set up trading strategies as instruments, thereby enabling much more accurate simulation of risk (i.e., the future portfolios created by the strategy can be tracked in the face of shifting risk factors, rather than simply examining the sensitivities of the current portfolio to the same). This enables the accurate ‘event horizon’ of simulation to be extended further into the future, and is also of significant benefit when stress testing.

A Stress Testing Subsystem

The risk reporting system just described can (and should) also be operated in a distributed stress testing mode. In this mode, the FoF simulation controller starts up the RiskBLADEs in each of the funds and has them load up their current portfolio constructions (note—stress testing can also be performed as part of optimization, but that is a separate discussion). Then, the simulation controller determines the sensitivity of the global portfolio to large (extreme) movements in the underlying risk factors. An advantage of the RiskBLADE architecture is that because each instrument is represented by a software component, non-linear instruments may be accurately modeled even in extreme offsets. The convexity of the return profile during stress tests is of great importance when determining the stability of a portfolio under stress.

Clearly, the FoF has a choice in both determining what constitutes a valid ‘extreme’ move for stress testing (for example, extreme historical risk factor moves could be considered, or a more bottom-up approach could be taken to creating a high-covariance state and running Monte Carlo simulations against that); there is a good deal of art inherent in this procedure. Furthermore, the FoF must decide what constitutes an ‘acceptable’ exposure in stress test scenarios, and what to do if the fund exceeds this (clearly, for optimization, these extremes will act as constraints).

It is important to run both the risk analysis and stress test analysis across the portfolio as frequently as possible, because it is likely a global optimization will take place relatively infrequently (perhaps once a week or once a month), and local allocation decisions will have to be made between those points. Furthermore, where the ‘instruments’ used by a fund are strategies, large changes in sensitivity can occur should the manager change the strategy ‘on the fly’. Two points are worth making here. Firstly, a screen can be run on the daily risk reports to show any large changes in risk factor (up or down) exposure, taken from the previous day. This is a valuable alarm system to have in place. Secondly, it must be remembered that the primary job of the overall optimizer is to allocate to instruments, some (most?) of which may actually be <underlying instrument, trading strategy> tuples—that is to say, we are interested in how an allocation to a trading strategy over an instrument will work out, or equivalently, that allocation is not the same thing as trade sizing.

An Optimization Cost Analysis and Fund Relationship

As we described (simplistically) with the example above, what makes sense globally for a fund of funds as a risk budget, does not necessarily make best sense for its underlying funds considered standalone. Therefore, in general it will cost a given fund money (in terms of lost risk-adjusted returns and hence incentive fees) to host a particular risk profile specified as a result of global optimization. As a consequence of this, under the current FoF-fund relationship, there is no incentive to the fund (provided its base product attracts strong demand from the general market) to offer FoFs the ability to set specific risk budgets. Why accept constraints on what you do for a negative payoff?

The solution to this problem that we propose acts as an adjunct to the RiskBLADE technology. There is no reason why (if underlying funds are willing to take the cost) that the RiskBLADE architecture could not be utilized independently of the following, but in general we believe that it makes a useful addition to the discussion, and so we introduce it here.

The basic idea is for a fund to create for each FoF a special account, termed a segregated account, in which the fund will carry out trades on behalf of that FoF. Unlike a managed account, a segregated account does not provide position transparency, but it does provide sophisticated risk transparency, support the RiskBLADE portfolio architecture, and (within the local constraints specified by the manager) allows the FoF to set an explicit risk budget for the fund itself.

Now, here is the key point. Looked at purely from a performance fees perspective, the fund will lose a certain amount of benefit from following this risk budget, as compared its optimal local risk budget (the budget, if you recall, that makes for the best standalone fund, rather than the best portfolio addition to a global FoF). However, given that the fund (on average) takes a 20% performance fee (20% of the net new profits), there is an imbalance between the benefits to the FoF (approximately 80% of the risk adjusted returns) and to the underlying funds (who sacrifice only 20% of the local shortfall, due to their fee structure). Therefore, the FoF would still (in a large number of cases) derive value even if it had to pay the fund the returns it has foregone by pursuing the globally optimal allocation strategy. Of course, since this is an additional cost, the FoF will never quite be able to obtain the ‘theoretical’ globally optimal risk-adjusted-return through this methodology, but it will do better (in general) than a simple aggregator. In any event, we need to make the following two points:
The process is self limiting, in that the ‘cost of compensation’ paid to the fund represents a constraint on the optimization, since there is always the option for the fund to simply locally optimize and for the FoF to optimally aggregate, which by definition carries no compensation load. Therefore only a global allocation strategy that, net of this ‘alpha swap’ provides a better objective function value for the FoF, will be entertained by the optimizer.
The ‘gap’ between the risk-adjusted returns (strictly, objective function value. It is possible that a FoF may not treat risk adjusted return as the objective function to be optimized. However, this is more likely when the FoF is in fact operating for e.g. a pension fund (or is a pension fund) where the external compensation structure is less absolute-value driven) available theoretically for the globally optimal portfolio, and those attainable with the compensation payments in place, represents (in one sense) the costs of a FoF providing for its clients true diversification (lots of different managers) with lowered business risk (since the managers are housed in different companies). Therefore, it can be argued with some conviction that this approach allows FoFs to attain an optimal portfolio balance when compared to multi-strats. The point is that performance of a well-run FoF utilizing this methodology should exceed that of a multi-strat (risk budgeting having been normalized, and the FoF having a wider choice of strategies and idiosyncratic alpha from which to chose); however, this additional performance plus the additional manager risk insulation from diversity must equal or exceed the cost of the additional fee layer plus the cost of the alpha swap.

Now, there are a few points that should be made regarding this compensation scheme for funds (which we have termed an ‘alpha swap’). Firstly, it is reasonable that funds should only be compensated for loss of income due to lower performance fees, not lower management fees, as computing the transfer function between performance, volatility and fund flows is extremely thorny.

Secondly, we must have a good understanding of what the fund ‘would have done’ left to optimize locally. The simplest approach here is simply to take the returns of the fund's main program (not the segregated account) and use these as the basis, then compensate for 20% of the risk-adjusted performance shortfall in the segregated account with respect to this program. This is probably the simplest and best approach in most circumstances, and leaves little leeway for fudging since the reference portfolio is audited. An alternative would be to have the fund provide its ‘shadow’ trading decisions (perhaps as the signatures generated by digitally signing the portfolio with their private key under a public key encryption system) during the measurement period, and then comparing this marked portfolio's performance at the end. This approach allows a degree of path-dependency (i.e., compares how the fund would have managed given these starting assets and its own risk budget). Clearly, there would also need certain risk constraints satisfied by the theoretical portfolio also. The public key signature would enable the FoF to ensure that the ‘would have’ portfolio disclosed by the fund ex post matches those decisions they actually made ex ante, so cheating is not possible.

Thirdly, the compensation (reflecting the optionality in the fee structure) is one-way; that is, if the FoF's risk budget creates an outperforming segregated account on a risk-adjusted basis, there is no expectation that the fund should compensate the FoF!

Finally, the compensation baseline should be reset at the start of each period (most likely, each month or quarter) to account for the fact that compensation has been paid to the fund already for the previous term's underperformance (if any).

With the caveat to the reader that our original example was a deliberately simple one, it is useful for the sake of completeness to quantify the effect of adding an alpha swap into that scenario.

Assuming that we do, so that the ‘virtual losses’ in the underlying funds are compensated with respect to the weight of starting capital allocated to each fund by the FoF, then the effective Sharpe ratio of the optimized fund falls from 1.84 to 1.80; nevertheless, this reduced figure is still greater than the 1.57 Sharpe ratio available to the FoF pursuing the ensure aggregation’ policy, and so intuitively the value of alpha swap may be seen. Of course, the underlying funds should now be indifferent to offering either capacity for the segregated account or the normal fund—their incentive fee (assuming risk-normalized returns) will be the same in either case. This is slightly simplified in that one should really optimise the function that includes the payment of the alpha swap, and indeed that could be done, but we only require the simpler working to make the point.

Benefits of the RiskBLADE Architecture

The RiskBLADE architecture, as described here, has many benefits for adopting managers and funds-of-funds. As have discussed, FoFs are under increasing pressure from multi-strats. The best way for them to counter this threat is to become distributed, virtual multi-strats themselves. To this end, we described three key objectives for a risk budgeting architecture that aims to facilitate such an outcome:
It must facilitate risk transparency, not position transparency, and use a common risk taxonomy throughout.
It must enable FoFs to actively set risk budgets for their underlying funds, rather than simply being passive aggregators of risk.
It must enable the use of a distributed portfolio optimization approach, so that funds’ risk budgets are set to maximize global, rather than local, objective functions. It must sit within a structure that makes this non-punitive for the underlying funds.

As hopefully has been made clear in the foregoing, the RiskBLADE architecture clearly meets these goals. Specifically:
Transparency and a common risk taxonomy are supported. The RiskBLADE architecture supports a detailed risk model that can be used for ex ante risk budgeting, current position risk analysis, and ex post performance attribution. The use of a distributed portfolio architecture with instruments implemented though an API in software means that it is possible to have very up-to-date risk reporting, without this requiring position transparency on behalf of the funds.
Under the RiskBLADE architecture, FoFs can actively set a risk budget for funds to follow, using the ‘menu’ of choices open to them. Ex post, the fund's adherence to this risk budget can then be tested.
Importantly, a global, distributed view of the portfolio is made possible through the use of a networked optimizer. This powerful technique allows FoFs (operating with segregated accounts) to create virtual multi-strats that are just as responsive as in-house multi-strat products, but which have the benefits of greater alpha diversity and (much) lower overall manager risk.

Funds adopting the RiskBLADE technology should benefit from a much clearer and more advanced approach to risk management, with internal tracking to ensure that they do not become unwittingly exposed to unwanted risk factors (they also gain the use of a stress-testing subsystem to assist in this). They get the ability to optimize their own fund locally within a set of risk constraints defined within a standardized risk taxonomy. And the process of performance tracking and reporting etc. is simplified through the use of the automated toolset provided for this purpose.

On a more subtle level, the ability to contribute to a globally optimized blended FoF helps protect individual adopting hedge funds against the rising barriers to entry that multi-strats are creating. It helps keep the business model valid for startups whose alpha proposition may be highly concentrated on a single style.

Fund of funds (FoFs) adopting the RiskBLADE technology benefit by being able to take active control over the risk budgets of the funds in which they are invested, and in addition gain a much greater oversight of their overall exposures at a portfolio level. Furthermore, FoFs can actively track their underlying funds with explanatory breakouts of the true sources of their performance, run comparative analyses versus the peer group, and check for evidence of style drift. And as we have seen, even where FoFs use alpha swaps to compensate funds for lost revenue through the use of global (rather than local) optimization, significant portfolio benefits from global optimization can still accrue.

Taken as a whole, the RiskBLADE approach enables FoFs to move to the next level of alpha provision, and truly become distributed, virtual multi-strategy players.

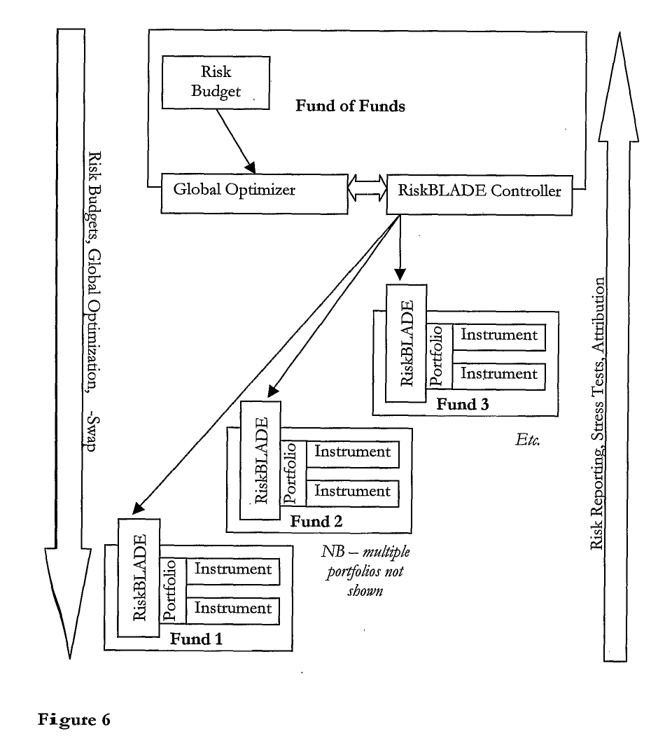

The diagram in FIG. 6 summarizes the modified architecture of a fund/FoF relationship, given the use of the new architecture:

As may be appreciated, the RiskBLADE architecture has advantages when compared with other products in the market, for example:
It provides a wider set of explanatory risk factors than are supported by RiskMetrics.
It provides the ability to support Monte Carlo simulation, not catered for by Risk Fundamentals (this is important, because simulation of derivatives etc. in general requires a Monte Carlo to obtain accuracy).
Most important, it provides (which the competitors do not) a means to globally optimize a portfolio of potentially complex instruments without requiring position disclosure on behalf of the contributing funds, and it provides a mechanism thereby which enables FoFs to set an explicit risk budget for their underlying investments.

This is summarized in the table below:

| | Risk | | |
|---|---|---|---|
| | Fundamentals | Risk Metrics | RiskBLADE |
| Sufficient set of | ✓ | x | ✓ |
| explanatory risk | | | |
| factors | | | |
| Capture of non- | ✓ | x | ✓ |
| price risk such | | | |
| as liquidity and | | | |
| leverage | | | |
| Support for Monte | x | ✓ | ✓ |
| Carlo simulation | | | |
| Ability to set risk | x | x | ✓ |
| budget for | | | |
| underlying funds | | | |
| Ability to optimize | x | x | ✓ |
| portfolio in a | | | |
| distributed manner | | | |
| across funds | | | |
| Systematic trading | x | x | ✓ |
| strategies | | | |
| supported as | | | |
| virtual instruments | | | |

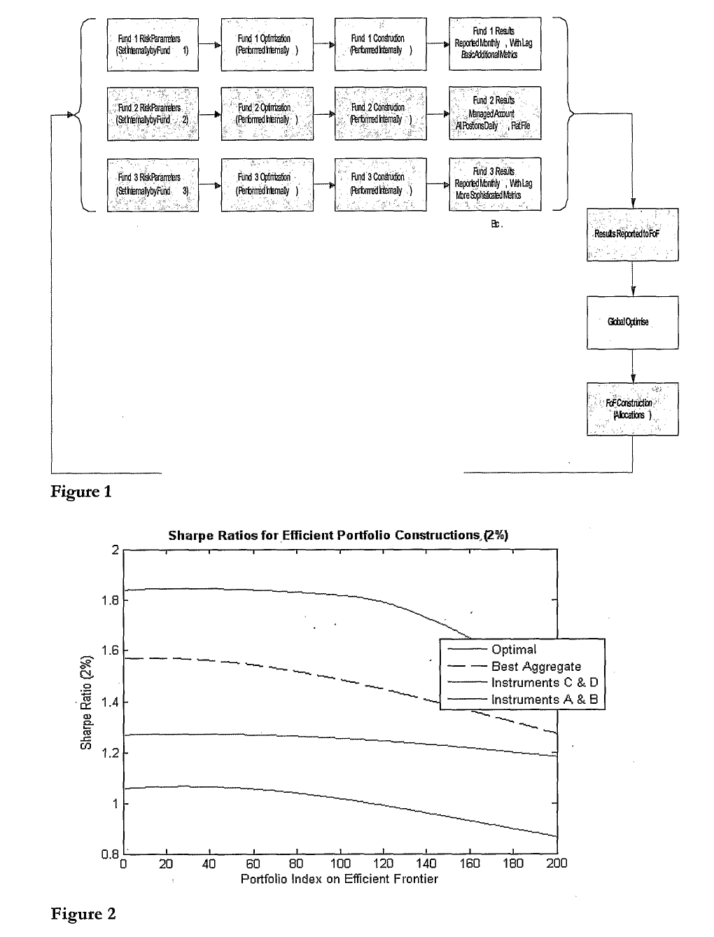

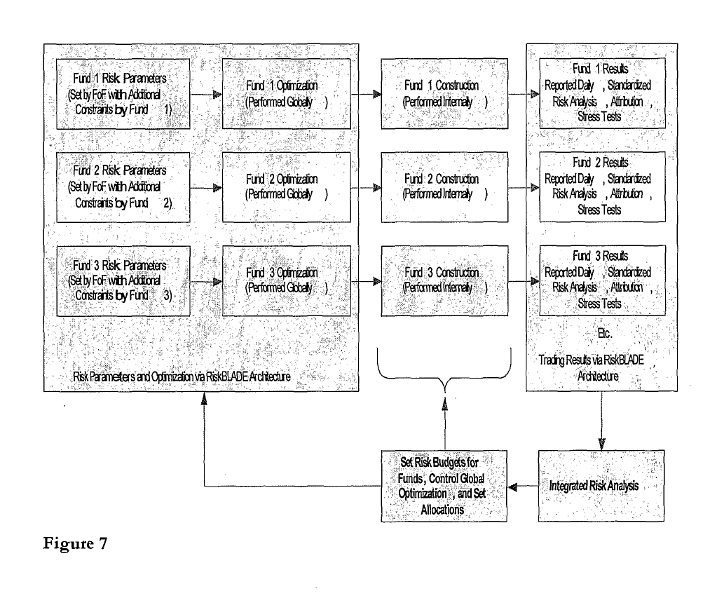

The improved flow, decision and control process made possible by the RiskBLADE architecture is shown FIG. 7 (compare this with FIG. 1, in which the passive allocation cycle is depicted):

### SUMMARY

In this document, we hare shown why fund-of-funds (FoFs) are coming under pressure from aggressive multi-strategy groups, not only because of the market's perception of the additional fee layer charged by FoFs, but also because of the sub-optimality of aggregating, passively, the performance profiles of underlying funds, compared with the mote dynamic risk control practiced by competitors.

To fight this threat, we believe that FoFs will have to become multi-strats—but in a virtual, distributed sense. Unfortunately, the current risk management technology utilized by funds prevents this desirable outcome from taking place.

This is where Crescent's RiskBLADE architecture comes in. RiskBLADE enables FoFs to actively participate in setting the risk budgets for those participating funds in which it is invested. It enables global optimization of instrument allocation across funds, without requiring position transparency. It provides an integrated methodology for ex ante risk budgeting, highly transparent risk exposure analysis and stress testing, and ex post performance attribution.

Closing Remarks

A venture capitalist sitting on the board of a private company in its portfolio, expects to exercise significant control over the financial budget of that company, while not wishing to get in the way of the implementation skills of the day-to-day management team. Shouldn't a fund-of-funds have a similar say over the risk budgets of the funds in which it is invested?

With the RiskBLADE architecture from Crescent, this is finally possible. RiskBLADE enables fund-of-funds to become active risk shapers, rather than passive risk aggregators, and as such, to gain first mover advantage in the race for next generation alpha.

1. A secure communication network operating between a central administrator, operating as a hedge fund of funds, and numerous separate investment funds, each investment fund including several different instruments, in which each instrument in a portfolio is modelled as a software component that responds to a common risk factor response API.

2. The communication network of claim 1 in which the software components enable the central administrator to actively set a risk budget for its underlying, individual funds or associated managers.

3. The communication network of claim 1 in which the software components can interact with the central administrator across a virtual domain through remote procedure calls to enable a virtual portfolio to be constructed by the central administrator.

4. The communication network of claim 2 in which the risk budget can be dynamically set by the central administrator in real time using a secure electronic protocol.

5. The communication network of claim 2 in which each instrument can declare or be queried using remote procedure calls to determine what queries are relevant and supported by the instrument.

6. The communication network of claim 2 in which the individual funds utilise a common risk model or taxonomy that delivers risk transparency but not position transparency to the hedge fund of funds, facilitating the active setting of risk budgets by the hedge funds of funds, the common risk model allowing each fund to perform or be subject to:
(a) predictive risk budgeting;
(b) portfolio evaluation during reporting; and
(c) retrospective performance attribution.

7. The communication network of claim 6 in which the hedge fund of funds can in real time globally optimise an actual or candidate portfolio of funds against a complex, objective function related to the risk budget, the objective function itself being modelled as a software component that also operates to the risk factor API.

8. The communication network of claim 7 in which the risk model is a taxonomy that expresses risk factors relating to leverage, liquidity, return volatility and correlation to key indices.

9. The communication method of claim 8 in which the risk budget uses the risk model to describe the applicable limits to the risk factors.

10. The communication network of claim 1 in which a trading strategy is treated as an instrument and modelled as a software component that responds to the common risk factor response API to give enhanced forward risk simulation of future portfolios.

11. The communication network of claim 3 in which What-If or Monte Carlo analysis is performed on instruments and/or the virtual portfolio.

12. The communication network of claim 9 in which the risk budget is expressed as one or more of the following:
(a) desired minimum and maximum exposures to each risk factor;
(b) desired minimum and maximum portfolio leverage;
(c) desired minimum and maximum time to liquidate various percentages of the portfolio;
(d) overall portfolio volatility minimum and maximum targets;
(e) overall portfolio return minimum and maximum targets; and
(f) maximum acceptable drawdowns in specified stress test scenarios.

13. The communication network of claim 1 in which each fund creates a separate segregated account that is uses to carry out trades for the hedge funds of funds, the segregated account facilitating risk transparency and risk optimisation.

14. The communication network of claim 12 in which the segregated account for a fund enables the hedge funds of funds to determine compensation payments to be made to the fund to compensate the fund for operating in a way that conforms to the risk budget specified by the hedge funds of funds.

15. A method of enabling a hedge fund of funds to manage risk, comprising the step of the hedge fund of funds actively setting a risk budget for its underlying, individual funds or associated managers.

16. The method of claim 15 in which the risk budget can be dynamically set by the hedge funds of funds in real time using a secure electronic protocol

17. The method of claim 16 in which the individual funds utilise a common risk model or taxonomy that delivers risk transparency but not position transparency to the hedge fund of funds, facilitating the active setting of risk budgets by the hedge fund of funds, the common risk model allowing each fund to perform or be subject to:
(a) predictive risk budgeting;
(b) portfolio evaluation during reporting; and
(c) retrospective performance attribution.

18. The method of claim 17 in which the hedge fund of funds can globally optimise a portfolio of funds against a complex, objective function related to the risk budget.

19. The method of claim 17 in which the risk model is a taxonomy that expresses risk factors relating to leverage, liquidity, return volatility and correlation to key indices.

20. The method of claim 19 in which the risk budget uses the risk model to describe the applicable limits to the risk factors.

21. The method of claim 20 in which the risk budget is expressed as one or more of the following:
(a) desired minimum and maximum exposures to each risk factor;
(b) desired minimum and maximum portfolio leverage;
(c) desired minimum and maximum time to liquidate various percentages of the portfolio;
(d) overall portfolio volatility minimum and maximum targets;
(e) overall portfolio return minimum and maximum targets; and
(f) maximum acceptable drawdowns in specified stress test scenarios.

22. The method of claim 19 in which each instrument in a portfolio is modelled as a software component that responds to a common risk factor response API.

23. The method of claim 22 in which a trading strategy is treated as an instrument and modelled as a software component that responds to the common risk factor response API to give enhanced forward risk simulation of future portfolios.

24. The method of claim 22 in which the hedge fund of funds can in real time globally optimise an actual or candidate portfolio of funds against a complex, objective function related to the risk budget, the objective function itself being modelled as a software component that also operates to the risk factor API.

25. The method of claim 22 in which the software components can interact across a virtual domain through remote procedure calls to enable a virtual portfolio to be constructed.

26. The method of claim 25 in which each instrument can declare or be queried using remote procedure calls to determine what queries are relevant and supported by the instrument.

27. The method of claim 25 in which What-If or Monte Carlo analysis is performed on instruments or the virtual portfolio for risk analysis or stress testing.

28. The method of claim 25 in which each fund creates a separate segregated account that is uses to carry out trades for the hedge funds of funds, the segregated account facilitating risk transparency and risk optimisation.

29. The method of claim 28 in which the segregated account for a fund enables the hedge funds of funds to determine compensation payments to be made to the fund to compensate the fund for operating in a way that conforms to the risk budget specified by the hedge funds of funds.
